(19) United States
(12) Patent Application Publication
(10) Pub. No.: US 2017/0302908 A1
(43) Pub. Date: Oct. 19, 2017

(54) METHOD AND APPARATUS FOR USER INTERACTION FOR VIRTUAL MEASUREMENT USING A DEPTH CAMERA SYSTEM

(71) Applicant: Motorola Mobility LLC, Chicago, IL (US)

(72) Inventor: By-Her W. Richards, Lincolnshire, IL (US)

(21) Appl. No.: 15/132,822

(22) Filed: Apr. 19, 2016

(51) Int. Cl. H04N 13/02; G06F 3/041; G06K 9/00; H04N 5/247

(52) U.S. Cl. CPC H04N 13/0239; H04N 5/247; G06F 3/0416; G06K 9/00664

(57) ABSTRACT

A method and apparatus provide user interaction for virtual measurement using a depth camera system. According to a possible embodiment, an image of a scene can be displayed on a display of the apparatus. A first frame of the scene can be captured using a first camera on an apparatus. A second frame of the scene can be captured using a second camera on the apparatus. A depth map can be generated based on the first frame and the second frame. A user input can be received that generates at least a human generated segment for measurement on the displayed scene. A measurement overlay can be generated based on the user input and the depth map. The measurement overlay can indicate a measurement in the scene. The measurement overlay can be displayed on a frame of the scene on the display.

### BACKGROUND

### 1. Field

The present disclosure is directed to a method and apparatus for user interaction for virtual measurement using a depth camera system. More particularly, the present disclosure is directed to displaying a measurement overlay indicating a measurement in a scene based on a user input that generates at least a human generated segment.

### 2. Introduction

Presently, people enjoy taking pictures of friends, family, children, vacations, flowers, landscapes, and other scenes using digital cameras that have sensors. Devices that have digital cameras include cellular phones, smartphones, tablet computers, compact cameras, DSLR cameras, personal computers, and other devices that have digital cameras. Some devices have two cameras, such as in a depth camera system, that are used to generate three-dimensional (3D) images. A 3D image is generated from the two cameras using a depth map that is based on parallax, which is the displacement or difference in the apparent position of an object viewed along two different lines of sight. Because a depth map is generated on a device with a depth camera system, it would be useful to allow a user to interact with the device so the user can make virtual measurements of objects in a scene. Unfortunately, present devices do not adequately allow users to make virtual measurements in scenes.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is an example block diagram of a system according to a possible embodiment;

FIG. 2 is an example illustration of a measurement overlay according to a possible embodiment;

FIG. 3 is an example illustration of an apparatus according to a possible embodiment;

FIG. 4 is an example illustration of camera calibration according to a possible embodiment;

FIG. 5 is an example illustration of a graph of a pinhole camera model showing a conversion of camera coordinates to image coordinates according to a possible embodiment;

FIG. 6 is an example illustration of a conversion of scene coordinates to a camera coordinate system;

FIG. 7 is an example flowchart illustrating the operation of a device according to a possible embodiment; and

FIG. 8 is an example block diagram of an apparatus according to a possible embodiment.

### DETAILED DESCRIPTION

Embodiments provide a method and apparatus for user interaction for virtual measurement using a depth camera system. According to a possible embodiment, an image of a scene can be displayed on a display of the apparatus. A first frame of the scene can be captured using a first camera on an apparatus. A second frame of the scene can be captured using a second camera on the apparatus. A depth map can be generated based on the first frame and the second frame. A user input can be received that generates at least a human generated segment for measurement on the displayed scene. A measurement overlay can be generated based on the user input and the depth map. The measurement overlay can indicate a measurement in the scene. The measurement overlay can be displayed on a frame of the scene on the display.

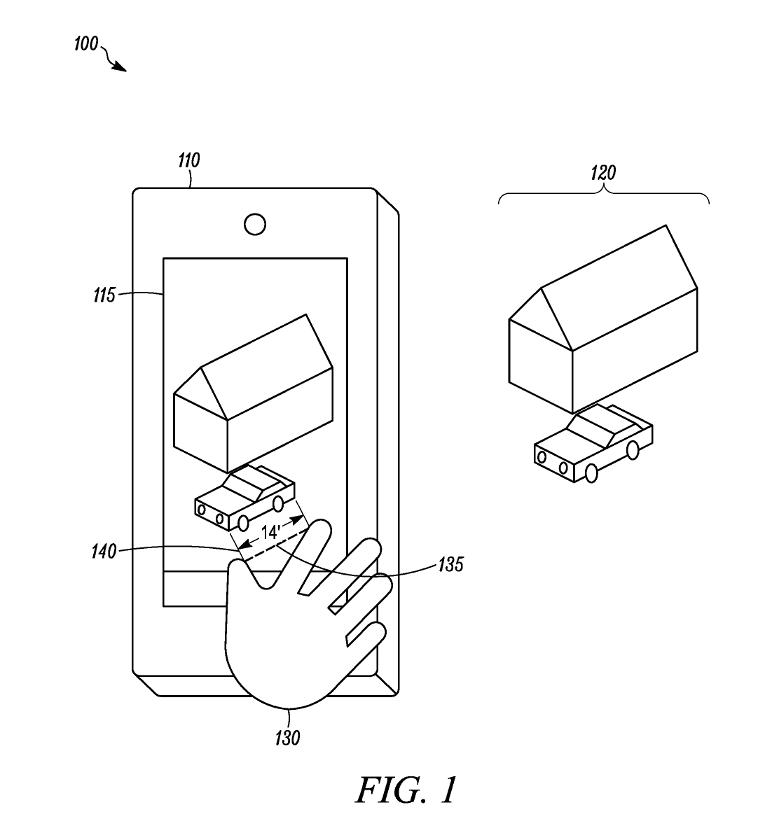

FIG. 1 is an example illustration of a system 100 according to a possible embodiment. The system 100 can include an apparatus 110 and a scene 120. The apparatus 110 can be a wireless terminal, a portable wireless communication device, a smartphone, a cellular telephone, a flip phone, a personal digital assistant, a personal computer, a selective call receiver, a tablet computer, a laptop computer, a webcam, a dedicated camera, or any other device that is capable of capturing an image of a scene. The apparatus 110 can include a display 115. The display 115 can be a Liquid Crystal Display (LCD), can be touchscreen display, can be an optical viewfinder, or can be any other display.

In operation according to a possible embodiment, an image of the scene 120 can be displayed on the display 115. A first frame of the scene 120 can be captured using a first camera on the apparatus 110. A second frame of the scene can be captured using a second camera on the apparatus 110. A depth map can be generated based on the first frame and the second frame. A user input 130 can be received that generates at least a human generated segment 135 for measurement on the displayed scene. A measurement overlay 140 can be generated based on the user input and the depth map. The measurement overlay 140 can indicate a measurement in the scene 120. The measurement overlay 140 can be displayed on a frame of the scene on the display 115.

For example, with a depth camera system, experiences can be enabled that are not feasible with cameras without depth information. Virtual measurement is one of them. With depth information provided in a depth camera system, length, area, volume, or other measurement of a line, an arc, an area, an object, or other elements may be measured during an image capture. Also, the image coordinates of a hand or fingers can be located with depth information. By using an algorithm in augmented reality, a user can use his or her fingers or hand to indicate a scene object or a segment for virtual measurement.

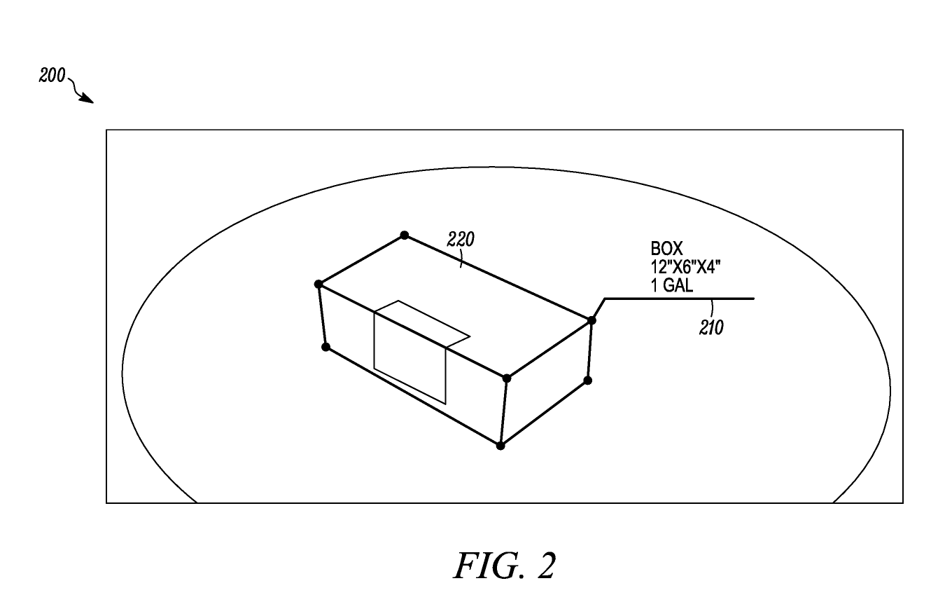

FIG. 2 is an example illustration 200 of a measurement overlay 210 according to a possible embodiment. For a touchscreen approach, given a scene object, such as a box 220, on a viewfinder, if a user places his or her finger near or on that scene object by touching the screen, then a measurement overlay 210, such as a box measurement, can be generated on the viewfinder. For example, lines, text, object name, size, volume, and other information can be displayed as part of the measurement overlay 210. If there are not any clear scene objects on the viewfinder, if a user touches the screen with two fingers, which defines a segment, then a segment measurement overlay can be generated on the viewfinder. If a user touches the screen with one finger and draws a closed contour around an area at scene on the view finder, which defines the area, an area measurement overlay of the closed contour can be generated on the viewfinder.

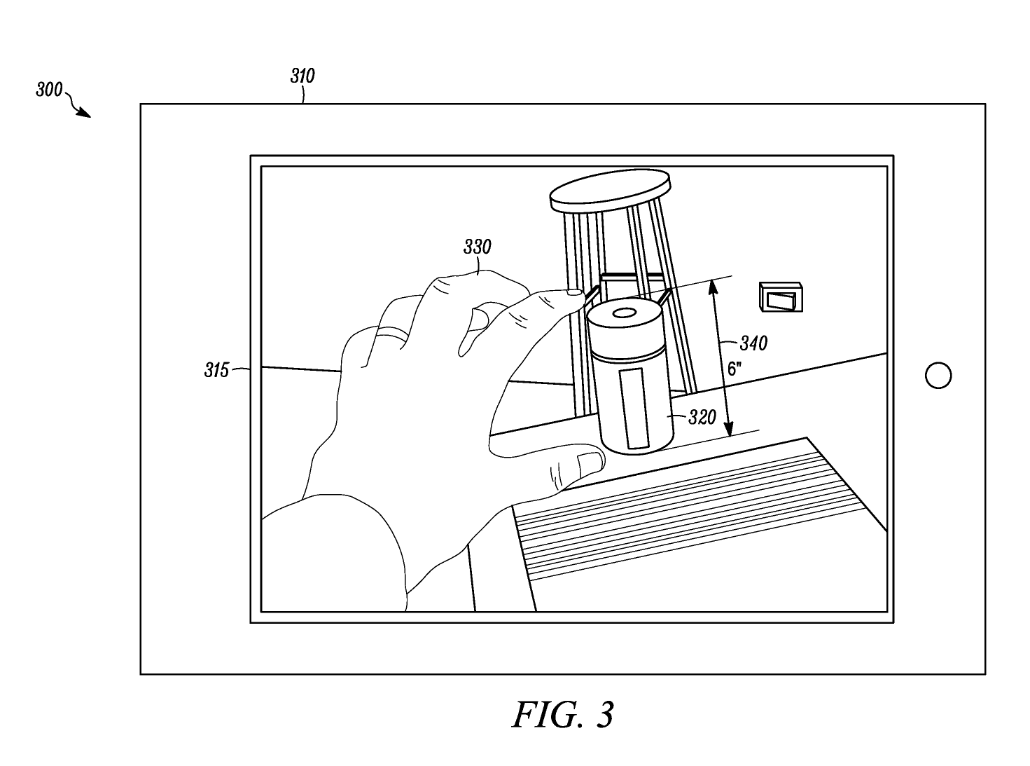

FIG. 3 is an example illustration of an apparatus 310, such as the apparatus 110, according to a possible embodiment. The apparatus 310 can include a display 315, such as the display 115. The apparatus 310 can operate similarly to the apparatus 110. According to this possible embodiment, the apparatus 310 can use augmented reality, such as a virtual user input from a user 330, to generate the measurement overlay 340. According to possible embodiments, the apparatus 310 can use augmented reality, a touchscreen display, or any other element for user input to generate the measurement overlay 340.

For example, for an augmented reality approach, given a scene object, such as a bottle 320, on the viewfinder, such as the display 115, if a user 330 places his or her two fingers near that scene object, and those fingers are detected within the viewfinder 315, then an overlay 340 of a height measurement of the bottle 320 can be generated on the viewfinder 315. If there are not any clear scene objects on the viewfinder 315, if a user 330 places his or her two fingers to define a segment, and those fingers are detected within the viewfinder 315, the overlay 340 can be segment measurement overlay generated on the viewfinder 315. If a user 330 uses his or her finger to draw a closed contour around an area in a scene, and the finger is detected within the viewfinder 315, then an area measurement overlay can be generated on the viewfinder 315.

To implement an augmented reality approach for a frame in a preview mode on a viewfinder, an algorithm can be used to generate the corresponding depth map for that frame. This can mean that every pixel in that frame can have a corresponding depth value. For example, given a bottle 320 on the viewfinder 315, the depth map of preview frames can provide the distance between the bottle 320 and a camera on the apparatus 310. Also, a virtual measurement algorithm using the depth camera system configurations can derive the height of the bottle 320. If a user 330 places his or her two fingers near the bottle 320, and those fingers are detected within the viewfinder 315 by a gesture detection algorithm, then an image understanding algorithm can identify the user's intention, such as to get the height measurement of the bottle 320, by using the image coordinates of two finger tips. Then, an augmented reality algorithm can generate a height measurement overlay 340 of the bottle 320 on the viewfinder 315. By using the depth map of a preview frame, two fingers at a shorter distance from the apparatus 310 can be separated from the bottle 320 at a longer distance.

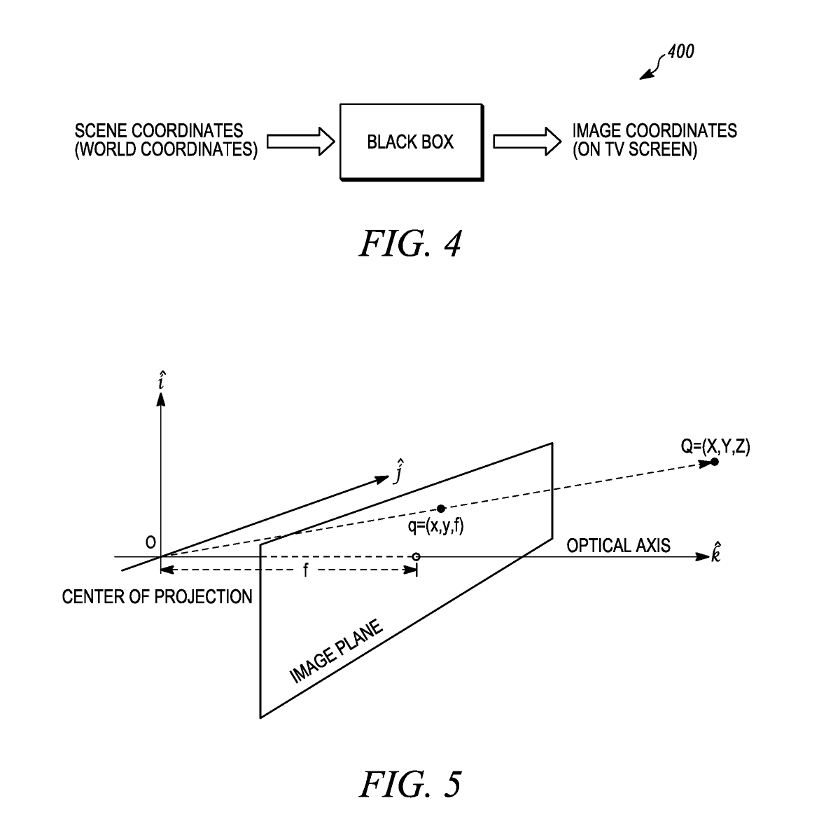

FIG. 4 is an example illustration 400 of camera calibration according to a possible embodiment. Camera calibration can be used to measure parameters for a black box for conversion from scene, such as real world, coordinates to image coordinates, such as on a display.

FIG. 5 is an example illustration 500 of a graph of a pinhole camera model showing the conversion of camera coordinates to image coordinates according to a possible embodiment. A point Q=(X, Y, Z) can be projected onto an image plane by a ray passing through the center of projection along an optical axis, and the resulting point on the image can be q=(x, y, f).

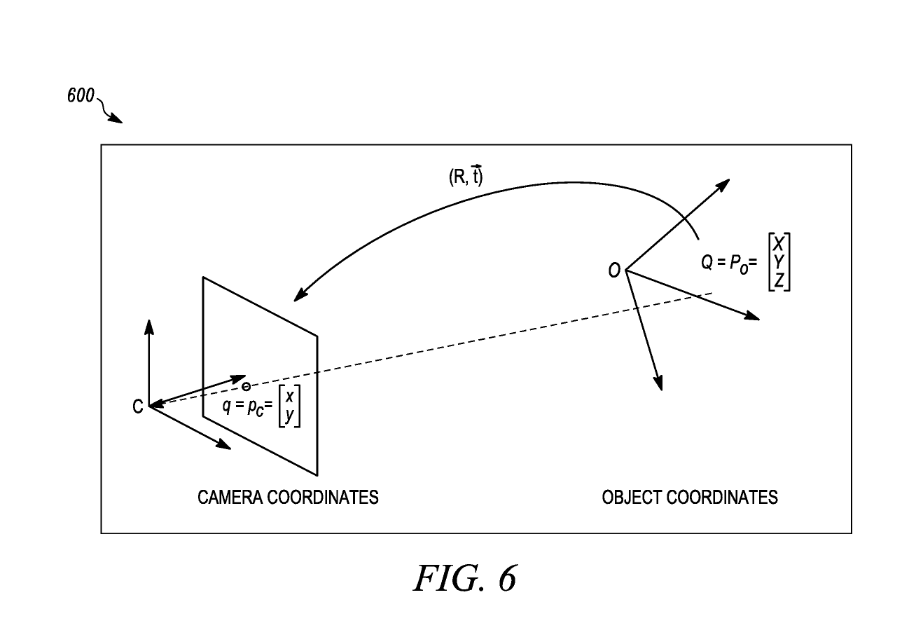

FIG. 6 is an example illustration 600 of the conversion of scene coordinates to a camera coordinate system. The point Pₒ on the object O in a scene is seen as the point p_{c} on an image plane. The point p_{c} is related to point Pₒ by applying a rotation matrix R and a translation vector t to Pₒ.

The illustrations 400, 500, and 600 illustrate how a relationship can be derived between scene coordinates and image coordinates by using single camera calibration. This means that the XYZ coordinate of a scene point can be derived from the image coordinates if single camera calibration data is available. A depth camera system can provide a high accuracy of the scene coordinate, such as in a Z axis.

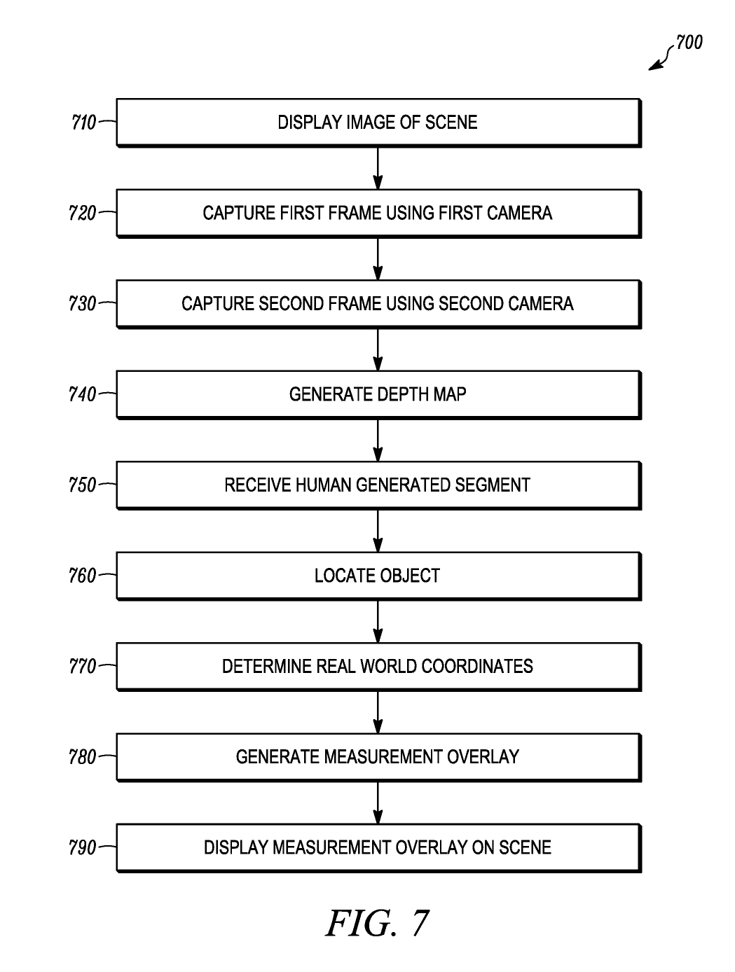

FIG. 7 is an example flowchart 700 illustrating the operation of an apparatus, such as the apparatus 110, according to a possible embodiment. At 710, an image of a scene can be displayed on a display of the apparatus. At 720, a first frame of the scene can be captured using a first camera on an apparatus. The term frame can mean a preview frame in a preview mode. In general, the term frame can also mean any image frame in preview mode, video mode, still capture mode, and any other mode that captures a frame of a scene. At 730, a second frame of the scene can be captured using a second camera on the apparatus. A depth camera system using the first and second cameras can use dual color cameras, at least one infrared camera, a time-of-flight camera, a range imaging camera system, a scanning laser, a combination of different cameras and sensors, and/or any other sensors that can detect depth of a scene and capture an image. At 740, a depth map can be generated based on the first frame and the second frame.

At 750, a user input can be received that generates at least a human generated segment for measurement on the displayed scene. The human generated segment can be generated based on a user's input, exclusive of what is present in the first and second frames. In particular, a human generates the segment. The segment can be an individual segment, a contour, a portion of a closed contour, a portion of a painted area, or any other human generated segment that can indicate a desired measurement. The human generated segment can be generated by one or more people.

According to a possible embodiment, the user input can be at least two digits on at least one hand of at least one person. Digits on at least one hand of at least one person can include fingers and thumbs. The digits can be on one hand of one person or can be on different hands. The user input can also be based on other parts of human anatomy or other devices, such as a stylus, that a user can employ to generate at least a segment for a measurement. The user input can also be from multiple users, such as different hands of different users and even different users standing within the frame. For example, any human fingers, hands, and legs in a scene, or multiple users' hands, etc. can be detected and recognized by a gesture recognition algorithm Then, through an image understanding algorithm, the intent of visual measurement can be determined.

According to a possible implementation the first scene can include at least two human digits an area in the scene. For example, in augmented reality, given a scene object, such as a bottle, on a viewfinder, if a user puts his or her two fingers near the scene object on image coordinates, and the fingers are detected within the viewfinder, then an overlay of a height measurement of the bottle can be generated on the viewfinder. The depth of two fingers can be very far away from the depth of the scene object. The image coordinate system on the view finder may contain only x and y axes, and does not necessarily include an axis for depth, such as a z axis. Therefore, two fingers and the scene object can be very close on the image coordinates, but very far away from each other in the depth axis, such as a z-axis. According to another possible implementation, the display can be a touchscreen display and the user input can be the at least two human fingers touching the touchscreen display.

According to another possible embodiment, the user input can be a user drawing at least the human generated segment on the scene. For example, at least the first camera can detect the user drawing on the scene, such as using augmented reality. According to another possible embodiment, the user can draw on the scene using a touchscreen display. According to a possible implementation, the human generated segment can be a closed contour drawn around an area of the scene. The drawn closed contour can also be a painted area covering an area of the scene.

At 760, an object that is closest to the human generated segment in image coordinates of the first frame can be located. For example, object recognition can be used to locate the object by processing one or more preview frames. According to a possible implementation, an object can be located that is within the closed contour in image coordinates of the first frame.

At 770, real world coordinates can be determined for a measurement of the object based on the depth map. The real world coordinates of the scene object or of human fingers can both be generated. For the virtual measurement, image coordinates of human fingers can be used to find a nearby scene object by its image coordinates. Then, after identifying the scene object of interest the real world coordinates of this scene object can be used to perform the virtual measurement. The real world coordinates can be determined for a measurement of the object based on the depth map, image coordinates of the object, and camera calibration data.

At 780, a measurement overlay can be generated based on the user input and the depth map. The measurement overlay can be based on the real world coordinates. The measurement overlay can indicate a measurement in the scene. Generating a measurement overlay can include projecting the human generated segment onto an object in the scene based on the depth map to generate the overlay on the object in the scene. For example, generating a measurement overlay can include projecting the human generated segment onto an object in the scene based on the depth map, the image coordinates of the object, and the camera calibration data, to generate the measurement overlay on the object in the scene. According to a possible implementation, the measurement overlay can be an overlay of an area measurement. For example, an area within a closed contour can be measured with respect to real world coordinates and the measurement of the area can be overlaid on a frame of the scene in a display, such as a viewfinder. According to a possible implementation, the measurement overlay can be based on the user input, the depth map, image coordinates of the measured scene object, and camera calibration data.

At 790, the measurement overlay can be displayed on a frame of the scene on the display. Operations on the first frame can also include operations on the second frame as well as operations on a combination of the first frame and the second frame. Additional cameras and frames can also be used. The measurement overlay can be displayed on preview frames in a preview mode, can be saved as an image at in a still capture mode, and/or can be generated for any other mode. In a preview mode, preview frames can be updated many times per second. After the measurement overlay is displayed on the display, such as a viewfinder, the user can press a virtual or physical shutter button to take a picture. Then, the measurement overlay can be present be on the resulting picture when the user reviews it. The resulting picture can also be stored in memory, transmitted to another device, sent to a printer, or otherwise output.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

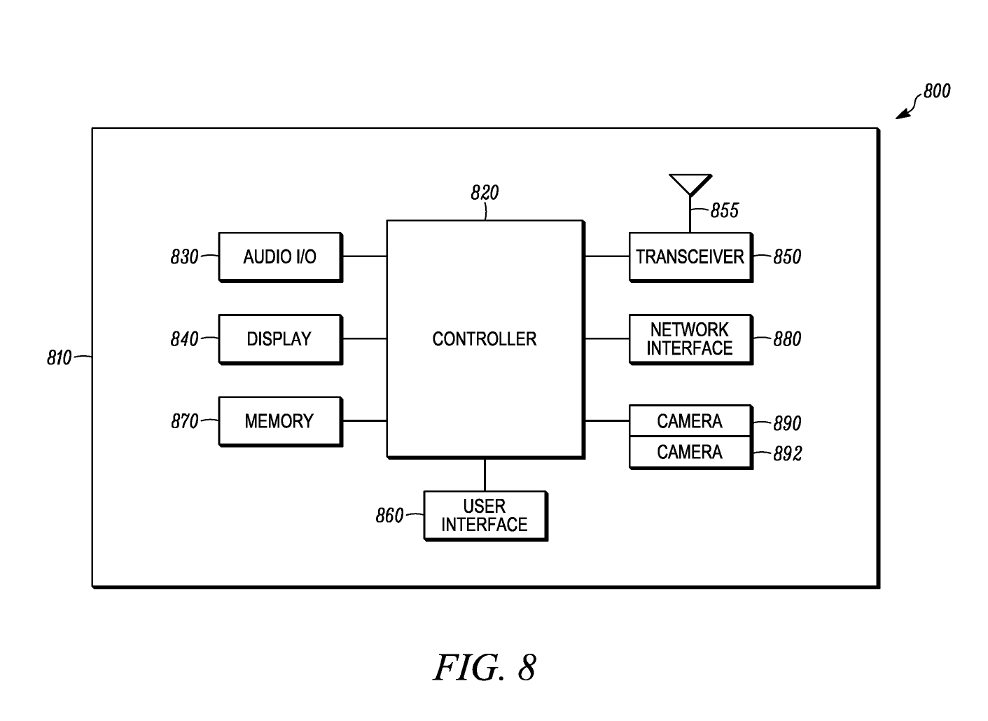

FIG. 8 is an example block diagram of an apparatus 800, such as the apparatus 110, according to a possible embodiment. The apparatus 800 can include a housing 810, a controller 820 within the housing 810, audio input and output circuitry 830 coupled to the controller 820, a display 840 coupled to the controller 820, a transceiver 850 coupled to the controller 820, an antenna 855 coupled to the transceiver 850, a user interface 860 coupled to the controller 820, a memory 870 coupled to the controller 820, and a network interface 880 coupled to the controller 820. The apparatus 800 can also include a first camera 890 and a second camera 892 coupled to the controller 820. The apparatus 800 can perform the methods described in all the embodiments.

The display 840 can be a viewfinder, a liquid crystal display (LCD), a light emitting diode (LED) display, a plasma display, a projection display, a touch screen, or any other device that displays information. The transceiver 850 can include a transmitter and/or a receiver. The audio input and output circuitry 830 can include a microphone, a speaker, a transducer, or any other audio input and output circuitry. The user interface 860 can include a keypad, a keyboard, buttons, a touch pad, a joystick, a touchscreen display, another additional display, or any other device useful for providing an interface between a user and an electronic device. The network interface 880 can be a Universal Serial Bus (USB) port, an Ethernet port, an infrared transmitter/receiver, an IEEE 1394 port, a WLAN transceiver, or any other interface that can connect an apparatus to a network, device, or computer and that can transmit and receive data communication signals. The memory 870 can include a random access memory, a read only memory, an optical memory, a flash memory, a removable memory, a hard drive, a cache, or any other memory that can be coupled to a device that captures images.

The apparatus 800 or the controller 820 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a .NET® framework, or any other application framework. The software and/or the operating system may be stored in the memory 870 or elsewhere on the apparatus 800. The apparatus 800 or the controller 820 may also use hardware to implement disclosed operations. For example, the controller 820 may be any programmable processor. Disclosed embodiments may also be implemented on a general-purpose or a special purpose computer, a programmed microprocessor or microprocessor, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 820 may be any controller or processor device or devices capable of operating a device and implementing the disclosed embodiments.

In operation, the display 840 can display an image of a scene. The first camera 890 can capture a first frame of the scene. The second camera 892 can capture a second frame of the scene. The controller 820 can generate a depth map based on the first frame and the second frame.

The controller 820 can receive a user input that generates at least a human generated segment for measurement on the displayed scene. The controller 820 can receive the user input via a touchscreen, via object detection on an image received from a camera, via sensors that detect human anatomy, or via any other element that receives a user input generating a human generated segment. According to a possible embodiment, the user input can be at least two digits on at least one hand of at least one person. The first scene can include the at least two human digits an area in the scene. According to a possible implementation, the user input can be the at least two human fingers touching a touchscreen display. According to another possible embodiment, the user input can be the user drawing at least the human generated segment on the scene. The human generated segment can be a closed contour around an area of the scene.

According to a possible embodiment, the controller 820 can locate an object that is closest to the human generated segment in image coordinates of the first frame and can determine real world coordinates for a measurement of the object based on the depth map. The controller 820 can generate a measurement overlay based on the user input and the depth map. The measurement overlay can indicate a measurement in the scene. The measurement overlay can be based on real world coordinates. According to a possible embodiment, the controller 820 can generate the measurement overlay by projecting a human generated segment onto an object in the scene based on the depth map to generate the overlay on the object in the scene. The display 840 can display the measurement overlay on a frame of the scene.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of” or “at least one selected from the group of” followed by a list is defined to mean one, some, or all, but not necessarily all of, the elements in the list. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

We claim:

1. A method comprising:
displaying an image of a scene on a display of the apparatus;
capturing a first frame of the scene using a first camera on an apparatus;
capturing a second frame of the scene using a second camera on the apparatus;
generating a depth map based on the first frame and the second frame;
receiving a user input that generates at least a human generated segment for measurement on the displayed scene;
generating a measurement overlay based on the user input and the depth map, the measurement overlay indicating a measurement in the scene; and
displaying, on the display, the measurement overlay on a frame of the scene.

2. The method according to claim 1, further comprising:
locating an object that is closest to the human generated segment in image coordinates of the first frame; and
determining real world coordinates for a measurement of the object based on the depth map,
wherein the measurement overlay is based on the real world coordinates.

3. The method according to claim 1, wherein the user input comprises at least two digits on at least one hand of at least one person.

4. The method according to claim 3, wherein the first frame includes at least two human digits in the scene.

5. The method according to claim 3,
wherein the display comprises a touchscreen display, and
wherein the user input comprises the at least two human fingers touching the touchscreen display.

6. The method according to claim 1, wherein the user input comprises drawing at least the human generated segment on the scene.

7. The method according to claim 6, wherein generating a measurement overlay comprises projecting the human generated segment onto an object in the scene based on the depth map to generate the overlay on the object in the scene.

8. The method according to claim 6, wherein the human generated segment comprises a closed contour drawn around an area of the scene.

9. The method according to claim 8, wherein the measurement overlay comprises an overlay of an area measurement.

10. The method according to claim 8, further comprising:
locating an object that is within the closed contour in image coordinates of the first frame; and
determining real world coordinates for a measurement of the object based on the depth map,
wherein the measurement overlay is based on the real world coordinates.

11. The method according to claim 1, wherein determining real world coordinates comprises determining real world coordinates for a measurement of the object based on the depth map, image coordinates of the object, and camera calibration data.

12. The method according to claim 1, wherein generating a measurement overlay comprises generating the measurement overlay based on the user input, the depth map, image coordinates of the measured scene object, and camera calibration data.

13. An apparatus comprising:
a display to display an image of a scene;
a first camera to capture a first frame of the scene;
a second camera to capture a second frame of the scene;
a controller to
generate a depth map based on the first frame and the second frame,
receive a user input that generates at least a human generated segment for measurement on the displayed scene, and
generate a measurement overlay based on the user input and the depth map, the measurement overlay indicating a measurement in the scene,
wherein the display displays the measurement overlay on a frame of the scene.

14. The apparatus according to claim 13,
wherein the controller locates an object that is closest to the human generated segment in image coordinates of the first frame and determines real world coordinates for a measurement of the object based on the depth map, and
wherein the measurement overlay is based on the real world coordinates.

15. The apparatus according to claim 13, wherein the user input comprises at least two digits on at least one hand of at least one person.

16. The apparatus according to claim 15, wherein the first scene includes the at least two human digits in the scene.

17. The apparatus according to claim 15,
wherein the display comprises a touchscreen display, and
wherein the user input comprises the at least two human fingers touching the touchscreen display.

18. The apparatus according to claim 13, wherein the user input comprises the user drawing at least the human generated segment on the scene.

19. The apparatus according to claim 18, wherein the controller generates a measurement overlay by projecting the human generated segment onto an object in the scene based on the depth map to generate the overlay on the object in the scene.

20. The apparatus according to claim 18, wherein the human generated segment comprises a closed contour around an area of the scene.
